(19) United States
(12) Patent Application Publication
(10) Pub. No.: US 2026/0109841 A1
(43) Pub. Date: Apr. 23, 2026

(54) METHOD FOR PRODUCING COMPOSITION

(71) Applicants: SUMITOMO CHEMICAL COMPANY, LIMITED, Tokyo (JP); NEWLIGHT TECHNOLOGIES, Inc., Huntington Beach, CA (US)

(72) Inventors: Mitsuyoshi SHIMANO, Ichihara-shi, Chiba (JP); Hiroshi FUKURODA, Ichihara-shi, Chiba (JP)

(21) Appl. No.: 19/113,219

(22) PCT Filed: Sep. 25, 2023
(86) PCT No.: PCT/JP2023/034767

§ 371 Date: Mar. 19, 2025

(30) Foreign Application Priority Data
Oct. 13, 2022 (JP) 2022-164949

(51) Int. Cl. C08L 23/12; C08J 3/20

(52) U.S. Cl. CPC C08L 23/12; C08J 3/201; C08J 2323/12; C08J 2423/08; C08J 2467/04; C08L 2203/30; C08L 2205/025; C08L 2205/035

(57) ABSTRACT

A method for producing a composition containing an olefin-based polymer A and a polyhydroxyalkanoate-based polymer B, the composition containing 99.9 to 70 parts by mass of the olefin-based polymer A and 0.1 to 30 parts by mass of the polyhydroxyalkanoate-based polymer B when a total amount of the olefin-based polymer A and the polyhydroxyalkanoate-based polymer B is 100 parts by mass, includes a step of supplying a material 1 containing an olefin-based polymer A from a main feed port of an extruder to the extruder and melting and kneading the material 1, and a step of supplying a material 2 containing a polyhydroxyalkanoate-based polymer B from a side feed port disposed downstream of the main feed port in the extruder to the extruder and melting and kneading the material 2.

### TECHNICAL FIELD

The present invention relates to a method for producing a composition.

### BACKGROUND ART

Conventionally, a resin composition containing an olefin-based polymer and a polyhydroxyalkanoate-based polymer is known. For such a resin composition, Patent Literature 1 discloses that an olefin-based polymer and a polyhydroxyalkanoate-based polymer are melted and kneaded by a kneader to obtain a composition.

### CITATION LIST

### Patent Literature

Patent Literature 1: Japanese Unexamined Patent Publication No. 2006-77063

### SUMMARY OF INVENTION

### Technical Problem

However, as a result of examination by the present inventors, it has been found that the mechanical strength is easily deteriorated in a composition containing a polyhydroxyalkanoate-based polymer and an olefin-based polymer.

The present invention has been made in view of the above problems, and an object thereof is to provide a composition containing an olefin-based polymer and a polyhydroxyalkanoate-based polymer and having an excellent mechanical strength.

### Solution to Problem

[1] A method for producing a composition containing an olefin-based polymer A and a polyhydroxyalkanoate-based polymer B,
the composition containing 99.9 to 70 parts by mass of the olefin-based polymer A and 0.1 to 30 parts by mass of the polyhydroxyalkanoate-based polymer B when a total amount of the olefin-based polymer A and the polyhydroxyalkanoate-based polymer B is 100 parts by mass,
the method including:
a step of supplying a material 1 containing the olefin-based polymer A from a main feed port of an extruder to the extruder to melt and knead the material 1; and
a step of supplying a material 2 containing the polyhydroxyalkanoate-based polymer B from a side feed port disposed downstream of the main feed port in the extruder to the extruder to melt and knead the material 2.

[2] The method described in [1], in which the material 2 containing the polyhydroxyalkanoate-based polymer B contains the polyhydroxyalkanoate-based polymer B and the olefin-based polymer A at the following mass ratio, wherein CA is a mass of the olefin-based polymer A in the material 2, and CB is a mass of the polyhydroxyalkanoate-based polymer B in the material 2,

$${C}_{B} / {C}_{A} = 95 / 5 to 5 / 95$$

[3] The production method described in [1] or [2], in which the olefin-based polymer A contains a propylene-based polymer.

[4] The production method described in any one of [1] to [3], in which the polyhydroxyalkanoate-based polymer B contains a structural unit of 3-hydroxybutyrate.

[5] The production method described in any one of [1] to [4], in which the olefin-based polymer A contains an olefin-based elastomer having a monomer unit derived from an α-olefin having 3 to 20 carbon atoms and a monomer unit derived from ethylene.

[6] The production method described in any one of [1] to [5], in which the composition contains an inorganic filler (D).

[7] The production method described in any one of [1] to [6], in which the composition contains 20 parts by mass or less of the polyhydroxyalkanoate-based polymer B when the total amount of the olefin-based polymer A and the polyhydroxyalkanoate-based polymer B is 100 parts by mass.

[8] The production method described in any one of [1] to [7], in which the composition is used for injection molding.

[9] A composition obtained by the method for producing a composition described in any one of [1] to [8].

[10] A molded body of the composition described in [9].

[11] The molded body described in [10], in which the molded body is a component for automobiles.

[12] The molded body described in [11], in which the component for automobiles is a bumper, a grill, a side molding, a mud guard, or an under cover.

[13] The molded body described in [11], in which the component for automobiles is an instrument panel, a door panel, a pillar, a scuff, a cowl, a toolbox, a finish end, or a tailgate.

### Advantageous Effects of Invention

According to the present invention, there is provided a composition containing an olefin-based polymer and a polyhydroxyalkanoate-based polymer and capable of increasing the mechanical strength of a molded body.

### BRIEF DESCRIPTION OF DRAWINGS

FIG. 1 is a schematic view illustrating an example of an extruder used in a production method according to an embodiment.

FIG. 2 is a schematic view of a flat plate used for hue inspection.

### DESCRIPTION OF EMBODIMENTS

Hereinafter, some embodiments of the present invention will be described in detail. However, the present invention is not limited to the following embodiments.

### (Method for Producing Composition)

A method for producing a composition according to a first embodiment of the present invention is a method for producing a composition an olefin-based polymer A and a polyhydroxyalkanoate-based polymer B. This composition contains 99.9 to 70 parts by mass of the olefin-based polymer A and 0.1 to 30 parts by mass of the polyhydroxyalkanoate-based polymer B when a total amount of the olefin-based polymer A and the polyhydroxyalkanoate-based polymer B is 100 parts by mass.

The production method of the present embodiment includes a step of supplying a material 1 containing a polyolefin (A) from a main feed port of an extruder to the extruder and melting and kneading the material 1, and a step of supplying a material 2 containing a polyhydroxyalkanoate (B) from a side feed port disposed downstream of the main feed port in the extruder to the extruder and melting and kneading the material 2.

### <Composition>

### <Olefin-Based Polymer A>

The olefin-based polymer A is a polymer containing 50 mass % or more of a structural unit derived from an olefin having 2 or more and 10 or less carbon atoms (provided that, the total amount of the olefin-based polymer is taken as 100 mass %). Examples of the olefin having 2 or more and 10 or less carbon atoms include ethylene, propylene, 1-butene, isobutene, 1-pentene, 2-methyl-1-butene, 3-methyl-1-butene, 2-methyl-1-pentene, 3-methyl-1-pentene, 4-methyl-1-pentene, 1-hexene, 1-octene, 1-nonene, 1-decene, 1-undecene, and 1-dodecene.

The olefin-based polymer A may contain a structural unit derived from a monomer except olefins having 2 or more and 10 or less carbon atoms. Examples of the monomer except olefins having 2 or more and 10 or less carbon atoms include aromatic vinyl monomers such as styrene; unsaturated carboxylic acids such as acrylic acid and methacrylic acid; unsaturated carboxylic acid esters such as methyl acrylate, ethyl acrylate, butyl acrylate, methyl methacrylate, and ethyl methacrylate; vinyl ester compounds such as vinyl acetate; conjugated dienes such as 1,3-butadiene and 2-methyl-1,3-butadiene (isoprene); and non-conjugated dienes such as dicyclopentadiene and 5-ethylidene-2-norbornene.

The olefin-based polymer A can be at least one selected from the group consisting of an ethylene-based polymer, a propylene-based polymer, and a butene-based polymer, and may be a combination of any two or more kinds thereof.

### (Ethylene-Based Polymer)

An ethylene-based polymer is a polymer containing 50 mass % or more of a structural unit derived from ethylene, and examples thereof include an ethylene homopolymer, an ethylene-1-butene copolymer, an ethylene-1-hexene copolymer, an ethylene-1-octene copolymer, and an ethylene-1-butene-1-hexene copolymer. The ethylene-based polymer may be a combination of two or more ethylene-based polymers.

The ethylene-based polymer may be an olefin-based elastomer having a monomer unit derived from an α-olefin having 3 to 20 carbon atoms and a monomer unit derived from ethylene. The content of the monomer unit derived from ethylene in the olefin-based elastomer is preferably 10 to 85 wt % (provided that the total weight of the olefin-based elastomer is 100 wt %). Examples of the α-olefin having 3 to 20 carbon atoms include propylene, 1-butene, isobutene, 1-pentene, 2-methyl-1-butene, 3-methyl-1-butene, 1-hexene, 2-methyl-1-pentene, 3-methyl-1-pentene, 4-methyl-1-pentene, 1-octene, 1-nonene, 1-decene, 1-undecene, and 1-dodecene, and propylene, 1-butene, 1-hexene, or 1-octene is preferable.

Examples of the olefin-based elastomer include an ethylene-propylene copolymer elastomer, an ethylene-1-butene copolymer elastomer, an ethylene-1-hexene copolymer elastomer, and an ethylene-1-octene copolymer elastomer. As the olefin-based elastomer, only one kind may be used, or two or more kinds may be used in combination. An ethylene-1-butene copolymer elastomer or an ethylene-1-octene copolymer elastomer is preferable.

### (Propylene-Based Polymer)

A propylene-based polymer is a polymer containing 50 mass % or more of a structural unit derived from propylene, and examples thereof include a propylene homopolymer, a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer. The propylene-based polymer may be a combination of two or more kinds of propylene-based polymers. It is suitable that the olefin-based polymer A is a propylene-based polymer.

Here, the propylene-based polymer will be described in detail.

The propylene-based polymer is a polymer containing a propylene unit in an amount of more than 50 mass % when the amount of all constituent units contained in the propylene-based polymer is 100 mass %. Examples of the propylene-based polymer include a propylene

homopolymer and a copolymer of propylene and another monomer copolymerizable with propylene. Such a copolymer may be a random copolymer (hereinafter, also referred to as a polypropylene-based random copolymer) or a block copolymer.

The propylene-based polymer may contain one kind of propylene-based polymer alone, or may contain two or more kinds of propylene-based polymers in any combination at any ratio.

Examples of the combination of two or more kinds of propylene-based polymers include a combination of two or more kinds of propylene homopolymers having different weight average molecular weights and the like, and a combination of the following polymer (I) and polymer (II). The propylene-based polymer may contain a heterophasic propylene polymerization material. Here, the heterophasic propylene polymerization material means a propylene-based polymer (composition) containing the following polymer (I) and polymer (II), in which the polymer (I) and the polymer (II) are not compatible with each other and form different phases.

Here, the polymer (I) is a polypropylene-based polymer containing a propylene unit in an amount of more than 80 mass % and 100 mass % or less when the amount of all constituent units is 100 mass %. The polymer (I) may be a propylene homopolymer or a copolymer of propylene and another monomer.

Furthermore, the polymer (II) is a polypropylene-based polymer which is a copolymer of a propylene unit and at least one kind of monomer unit selected from the group consisting of an ethylene unit and an α-olefin unit having 4 or more carbon atoms.

As each of the polymer (I) and the polymer (II), one kind of polymer may be used alone, or two or more kinds of polymers may be used in combination.

From the viewpoint of improving rigidity and impact resistance of a molded body of a resin composition, the propylene-based polymer is preferably one or more kinds selected from the group consisting of a propylene homopolymer and a heterophasic propylene polymerization material, and is more preferably a heterophasic propylene polymerization material.

From the viewpoint of further improving the rigidity of a molded body of a composition, the propylene-based polymer has an isotactic pentad fraction (also referred to as a [mmmm] fraction) of preferably 0.97 or more, more preferably 0.98 or more as measured by ¹³C-NMR.

It can be said that the closer the isotactic pentad fraction of the propylene-based polymer is to 1, the higher stereoregularity of a molecular structure of the propylene-based polymer is, and the higher crystallinity of the polypropylene-based polymer is.

When the propylene-based polymer is a copolymer, the isotactic pentad fraction can be measured for a chain of propylene units in the copolymer.

From the viewpoint of further improving molding processability of a propylene-based resin composition, the propylene-based polymer has a melt flow rate (MFR) of preferably 1 g/10 min or more, more preferably 2 g/10 min or more as measured in accordance with JIS K7210 under conditions of 230° C. and a load of 2.16 kgf. The melt flow rate of the polypropylene-based polymer is preferably 250 g/10 min or less and more preferably 200 g/10 min or less. In an aspect, the melt flow rate of the polypropylene-based polymer is preferably 10 g/10 min to 160 g/10 min.

The propylene-based polymer can be produced, for example, by a polymerization method using a polymerization catalyst.

Examples of the polymerization catalyst include a Ziegler type catalyst; a Ziegler-Natta type catalyst; a catalyst containing a compound containing a transition metal element of Group 4 of the periodic table and having a cyclopentadienyl ring and an alkylaluminoxane; a catalyst containing a compound containing a transition metal element of Group 4 of the periodic table and having a cyclopentadienyl ring, a compound that reacts with the compound to form an ionic complex, and an organic aluminum compound; and a catalyst in which a catalyst component (for example, a compound containing a transition metal element of Group 4 of the periodic table and having a cyclopentadienyl ring, a compound that forms an ionic complex, an organic aluminum compound, or the like) is supported on inorganic particles (for example, silica, clay minerals, or the like) and modified.

Furthermore, as the polymerization catalyst, a prepolymerization catalyst prepared by prepolymerizing a monomer such as ethylene or an α-olefin in the presence of the catalyst described above may be used. Examples of the Ziegler-Natta type catalyst include a catalyst in

which a titanium-containing solid transition metal component and an organometallic component are combined.

Specific examples of the above polymerization catalyst include conventionally known catalysts described in Japanese Patent Application Laid-Open Publication Nos. S61-218606, H05-194685, H07-216017, H09-316147, H10-212319, and 2004-182981.

Examples of the polymerization method include bulk polymerization, solution polymerization, and gas phase polymerization. Here, the bulk polymerization refers to a method for performing polymerization using a liquid olefin as a medium at a polymerization temperature. The solution polymerization refers to a method for performing polymerization in an inert hydrocarbon solvent such as propane, butane, isobutane, pentane, hexane, heptane, or octane. The gas phase polymerization refers to a method for polymerizing a monomer in a gaseous state in a medium which is the monomer in a gaseous state.

Examples of a method in the above polymerization method (polymerizing method) include a batch method, a continuous method, and a combination thereof. The polymerizing method may be a multistage method performed using a plurality of polymerization reaction tanks connected in series.

As various conditions (polymerization temperature, polymerization pressure, monomer concentration, catalyst putting amount, polymerization time, and the like) in a polymerization step according to the above polymerization method, any suitable conditions can be appropriately determined according to an intended propylene-based polymer.

In producing the propylene-based polymer, in order to remove a residual solvent contained in the propylene-based polymer polymerized by the above polymerization method and an impurity such as an oligomer by-produced in the polymerization step, the propylene-based polymer polymerized by the above polymerization method may be held, for example, at a temperature at which a residual solvent or an impurity such as an oligomer can be volatilized and at a temperature at which the propylene-based polymer cannot be melted, modified, or the like. Examples of such a method for removing an impurity include any conventionally known suitable methods described in Japanese Patent Application Laid-Open Publication No. S55-75410, Japanese Patent No. 2565753, and the like.

Hereinafter, the propylene homopolymer, the propylene-based random copolymer, and the heterophasic propylene polymerization material, each of which serves as the propylene-based polymer, will be described.

### (Propylene Homopolymer)

From the viewpoint of improving the fluidity of the composition and the toughness of a molded body of the composition, the propylene homopolymer has an intrinsic viscosity number [η] of preferably 0.1 to 2 dL/g, more preferably 0.5 to 1.9 dL/g, still more preferably 0.7 to 1.8 dL/g.

Furthermore, from the viewpoint of improving the fluidity of the composition and the toughness of a molded body of the composition, the propylene homopolymer has a molecular weight distribution Mw/Mn of preferably 3 or more and less than 7, more preferably 3 to 6. Here, Mw represents a weight average molecular weight, and Mn represents a number average molecular weight. Note that the molecular weight distribution is numerical value measured by gel permeation chromatography (GPC).

### (Propylene-Based Random Copolymer)

Examples of the propylene-based random copolymer include a random copolymer containing a propylene unit and an ethylene unit (hereinafter, referred to as a random copolymer (1)), a random copolymer containing a propylene unit and an α-olefin unit having 4 or more carbon atoms (hereinafter, referred to as a random copolymer (2)), and a random copolymer containing a propylene unit, and ethylene unit, and an α-olefin unit having 4 or more carbon atoms (hereinafter, referred to as a random copolymer (3)).

The α-olefin having 4 or more carbon atoms that can constitute the propylene-based random copolymer is preferably an α-olefin having 4 to 10 carbon atoms. Examples of the α-olefin having 4 to 10 carbon atoms include 1-butene, 1-pentene, 1-hexene, 4-methyl-1-pentene, 1-octene, and 1-decene, and 1-butene, 1-hexene, and 1-octene are preferable.

Examples of the random copolymer (2) include a propylene-1-butene random copolymer, a propylene-1-hexene random copolymer, a propylene-1-octene random copolymer, and a propylene-1-decene random copolymer.

Examples of the random copolymer (3) include a propylene-ethylene-1-butene copolymer, a propylene-ethylene-1-hexene copolymer, a propylene-ethylene-1-octene copolymer, and a propylene-ethylene-1-decene copolymer.

The content of the ethylene unit in the random copolymer (1) is preferably 0.1 to 40 mass %, more preferably 0.1 to 30 mass %, and still more preferably 2 to 15 mass %.

The content of the α-olefin unit having 4 or more carbon atoms in the random copolymer (2) is preferably 0.1 to 40 mass %, more preferably 0.1 to 30 mass %, and still more preferably 2 to 15 mass %.

The total content of the ethylene unit and the α-olefin unit having 4 or more carbon atoms in the random copolymer (3) is preferably 0.1 to 40 mass %, more preferably 0.1 to 30 mass %, and still more preferably 2 to 15 mass %.

The content of the propylene unit in each of the random copolymers (1) to (3) is preferably 60 to 99.9 mass %, more preferably 70 to 99.9 mass %, and still more preferably 85 to 98 mass %.

### (Heterophasic Propylene Polymerization Material)

As described above, the polymer (I) that can be contained in the heterophasic propylene polymerization material is a polymer containing a propylene unit in an amount of more than 80 mass % and 100 mass % or less. The total content of the monomer units except the propylene unit in the polymer (I) is usually 0 mass % or more and less than 20 mass %, and may be 0 mass % or 0.01 mass % or more.

Examples of the monomer unit except that propylene unit which may be included in the polymer (I) include an ethylene unit and an α-olefin unit having 4 or more carbon atoms.

The α-olefin unit having 4 or more carbon atoms that can constitute the polymer (I) is preferably an α-olefin having 4 to 10 carbon atoms, more preferably 1-butene, 1-hexene, and 1-octene, and still more preferably 1-butene.

Examples of the polymer (I) include a propylene homopolymer, a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer.

Among them, the polymer (I) is preferably a propylene homopolymer, a propylene-ethylene copolymer, a propylene-1-butene copolymer, and a propylene-ethylene-1-butene copolymer, and more preferably a propylene homopolymer from the viewpoint of the rigidity of a molded body containing the polypropylene-based resin composition.

The molecular weight distribution (Mw/Mn) of the polymer (I) measured by GPC is preferably 3 or more and less than 7 and more preferably 3 to 6.

As described above, the polymer (II) is a copolymer of a propylene unit and at least one kind of monomer unit selected from the group consisting of an ethylene unit and an α-olefin unit having 4 or more carbon atoms.

The total content of the ethylene unit and the α-olefin unit having 4 or more carbon atoms in the polymer (II) is preferably 20 to 80 mass % and more preferably 20 to 60 mass %.

The α-olefin having 4 or more carbon atoms that can constitute the polymer (II) is preferably an α-olefin having 4 to 10 carbon atoms. Examples of the α-olefin that can constitute the polymer (II) include similar examples to the above-described examples of the α-olefin that can constitute the polymer (I).

Examples of the polymer (II) include a propylene-ethylene copolymer, a propylene-ethylene-1-butene copolymer, a propylene-ethylene-1-hexene copolymer, a propylene-ethylene-1-octene copolymer, a propylene-ethylene-1-decene copolymer, a propylene-1-butene copolymer, a propylene-1-hexene copolymer, a propylene-1-octene copolymer, and a propylene-1-decene copolymer, a propylene-ethylene copolymer, a propylene-1-butene copolymer, and a propylene-ethylene-1-butene copolymer are preferable, and a propylene-ethylene copolymer is more preferable.

The content of the polymer (II) in the heterophasic propylene polymerization material is preferably 1 to 50 mass %, more preferably 1 to 40 mass %, still more preferably 5 to 30 mass %, and particularly preferably 8 to 25 mass % when the total content of the polymer (I) and the polymer (II) is 100 mass %.

Examples of the heterophasic propylene polymerization material include a combination of a propylene homopolymer and a (propylene-ethylene) copolymer, a combination of a propylene homopolymer and a (propylene-ethylene-1-butene) copolymer, a combination of a propylene homopolymer and a (propylene-ethylene-1-hexene) copolymer, a combination of a propylene homopolymer and a (propylene-ethylene-1-octene) copolymer, a combination of a propylene homopolymer and a (propylene-1-butene) copolymer, a combination of a propylene homopolymer and a (propylene-1-hexene) copolymer, a combination of a propylene homopolymer and a (propylene-1-octene) copolymer, and a combination of a propylene homopolymer and a (propylene-1-decene) copolymer, in which the polymer (I) is a propylene homopolymer.

Furthermore, other examples of the heterophasic propylene polymerization material include a combination of a (propylene-ethylene) copolymer and a (propylene-ethylene) copolymer, a combination of a (propylene-ethylene) copolymer and a (propylene-ethylene-1-butene) copolymer, a combination of a (propylene-ethylene) copolymer and a (propylene-ethylene-1-hexene) copolymer, a combination of a (propylene-ethylene) copolymer and a (propylene-ethylene-1-octene) copolymer, a combination of a (propylene-ethylene) copolymer and a (propylene-ethylene-1-decene) copolymer, a combination of a (propylene-ethylene) copolymer and a (propylene-1-butene) copolymer, a combination of a (propylene-ethylene) copolymer and a (propylene-1-hexene) copolymer, a combination of a (propylene-ethylene) copolymer and a (propylene-1-octene) copolymer, a combination of a (propylene-ethylene) copolymer and a (propylene-1-decene) copolymer, a combination of a (propylene-1-butene) copolymer and a (propylene-ethylene) copolymer, a combination of a (propylene-1-butene) copolymer and a (propylene-ethylene-1-butene) copolymer, a combination of a (propylene-1-butene) copolymer and a (propylene-ethylene-1-hexene) copolymer, a combination of a (propylene-1-butene) copolymer and a (propylene-ethylene-1-octene) copolymer, a combination of a (propylene-1-butene) copolymer and a (propylene-ethylene-1-decene) copolymer, a combination of a (propylene-1-butene) copolymer and a (propylene-1-butene) copolymer, a combination of a (propylene-1-butene) copolymer and a (propylene-1-hexene) copolymer, a combination of a (propylene-1-butene) copolymer and a (propylene-1-octene) copolymer, a combination of a (propylene-1-butene) copolymer and a (propylene-1-decene) copolymer; a combination of a (propylene-1-hexene) copolymer and a (propylene-1-hexene) copolymer, a combination of a (propylene-1-hexene) copolymer and a (propylene-1-octene) copolymer, a combination of a (propylene-1-hexene) copolymer and a (propylene-1-decene) copolymer, a combination of a (propylene-1-octene) copolymer and a (propylene-1-octene) copolymer, and a combination of a (propylene-1-octene) copolymer and a (propylene-1-decene) copolymer, in which the polymer (I) is a polymer containing a propylene unit and a monomer unit except the propylene unit. Note that, in the examples of the above combination, the polymer (I) is described first, and the polymer (II) is described later.

The heterophasic propylene polymerization material that can be contained in the polypropylene-based resin composition is preferably a combination of a propylene homopolymer and a (propylene-ethylene) copolymer, a combination of a propylene homopolymer and a (propylene-ethylene-1-butene) copolymer, a combination of a (propylene-ethylene) copolymer and a (propylene-ethylene) copolymer, a combination of a (propylene-ethylene) copolymer and a (propylene-ethylene-1-butene) copolymer, and a combination of a (propylene-1-butene) copolymer and a (propylene-1-butene) copolymer, and more preferably a combination of a propylene homopolymer and a (propylene-ethylene) copolymer.

The heterophasic propylene polymerization material can be produced by a production method including a multistage polymerization step including a first polymerization step of generating the polymer (I) and a second polymerization step of generating the polymer (II) in the presence of the polymer (I) generated in the first polymerization step. Polymerization of the heterophasic propylene polymerization material can be performed using the catalyst exemplified as the above-described catalyst that can be used for producing a polypropylene-based polymer.

The intrinsic viscosity number (hereinafter, referred to as [η]_{I}) of the polymer (I) is preferably 0.1 to 2 dL/g, more preferably 0.5 to 1.5 dL/g, and still more preferably 0.7 to 1.3 dL/g.

The intrinsic viscosity number (hereinafter, referred to as [η]_{II}) of the polymer (II) is preferably 1 to 10 dL/g, more preferably 2 to 10 dL/g, and still more preferably 2.5 to 8 dL/g.

Furthermore, a ratio of [η]_{II} to [η]_{I} ([η]_{II}/[η]_{I}) is preferably 1 to 20, more preferably 2 to 10, and still more preferably 2 to 9.

When the polypropylene-based polymer is a heterophasic propylene polymerization material composed of the polymer (I) and the polymer (II) formed by the multistage polymerization step as described above, a part of the polymer (I) generated in the first polymerization step is extracted from a polymerization tank in which the first polymerization step has been performed, the intrinsic viscosity number thereof is determined, the intrinsic viscosity number (hereinafter, referred to as [η]_{Total}) of the heterophasic propylene polymerization material finally generated in the second polymerization step is determined, and the intrinsic viscosity number of the polymer (II) generated in the second polymerization step is calculated using these intrinsic viscosity numbers and the contents.

Furthermore, when the heterophasic propylene polymerization material composed of the polymer (I) and the polymer (II) is produced by a production method in which the polymer (I) is obtained in the first polymerization step and the polymer (II) is obtained in the second polymerization step, the content of each of the polymer (I) and the polymer (II) and a procedure of measuring and calculating the intrinsic viscosity numbers ([η]_{Total}, [η]_{I}, and [η]_{II}) are as follows.

From the intrinsic viscosity number ([η]_{I}) of the polymer (I) obtained in the first polymerization step, the intrinsic viscosity number ([η]_{Total}) measured by the method described above for the final polymer (that is, the heterophasic propylene polymerization material composed of the polymer (I) and the polymer (II)) obtained in the second polymerization step, and the content of the polymer (II) contained in the final polymer, the intrinsic viscosity number [η]_{II} of the polymer (II) is calculated by the following formula.

$${[ η ]}_{I I} = ( {[ η ]}_{Total} - {[ η ]}_{I} \times {X}_{I} ) / {X}_{I I} \qquad Formula$$

wherein
[η]_{Total} represents the intrinsic viscosity number (unit: dL/g) of the final polymer,
[η]_{I} represents the intrinsic viscosity number (unit: dL/g) of the polymer (I),
X_{I} represents a weight ratio of the polymer (I) to the final polymer, and
X_{II} represents a weight ratio of the polymer (II) to the final polymer.
Note that X_{I} and X_{II} can be determined from a mass balance in the polymerization step.

Here, the weight ratio X_{II} of the polymer (II) to the final polymer may be calculated by the following formula using the crystal melting heat amount of each of the polymer (I) and the final polymer.

$${X}_{I I} = 1 - {( Δ Hf )}_{T} / {( Δ Hf )}_{P} \qquad Formula$$

wherein
(ΔHf)_{T} represents the melting heat amount (unit: cal/g) of the final polymer (polymer (I) and polymer (II)), and
(ΔHf)_{P} represents the melting heat amount (unit: cal/g) of the polymer (I).

### (Butene-Based Polymer)

A butene-based polymer is a polymer containing 50 mass % or more of a structural unit derived from 1-butene, and examples thereof include a 1-butene homopolymer, a 1-butene-ethylene copolymer, a 1-butene-propylene copolymer, a 1-butene-1-hexene copolymer, a 1-butene-1-octene copolymer, a 1-butene-ethylene-propylene copolymer, a 1-butene-ethylene-1-hexene copolymer, a 1-butene-ethylene-1-octene copolymer, a 1-butene-propylene-1-hexene copolymer, and a 1-butene-propylene-1-octene copolymer. The butene-based polymer may be a combination of two or more kinds of butene-based polymers.

The olefin-based polymer A can be produced by using a known polymerization method using a known polymerization catalyst.

### (Another Aspect of Olefin-Based Polymer A)

The olefin-based polymer A may be a mixture of a propylene-based polymer and an olefin-based elastomer.

In the olefin-based polymer A, the mass ratio of the propylene-based polymer and the olefin-based elastomer can be 1:20 to 20:1. In the olefin-based polymer A, the total mass of the olefin-based elastomer and the propylene-based polymer can be 50 mass % or more.

The melt mass flow rate (MFR) of the olefin-based polymer A as measured according to JIS K7210-2014 under conditions of 230° C. and a load of 2.16 kgf is preferably 0.1 g/10 min or more and 250 g/10 min or less. The melt mass flow rate (MFR) of the olefin-based polymer A may be 2 g/10 min or more or 10 g/10 min or more. The melt mass flow rate (MFR) of the olefin-based polymer A may be 250 g/10 min or less or 160 g/10 min or less.

### <Polyhydroxyalkanoate-Based Polymer B>

The polyhydroxyalkanoate-based polymer is a polyester of hydroxyalkanoic acid. Examples of the hydroxyalkanoic acid include 2-hydroxyalkanoic acid, 3-hydroxyalkanoic acid, and 4-hydroxyalkanoic acid.

Examples of the 2-hydroxyalkanoic acid include glycolic acid, lactic acid, and 2-hydroxybutyric acid. Examples of the polyester of the 2-hydroxyalkanoic acid, that is, poly(2-hydroxyalkanoate)-based polymer include polyglycolic acid and polylactic acid.

Examples of the 3-hydroxyalkanoic acid include 3-hydroxybutyric acid, 3-hydroxypropionic acid, 3-hydroxypentanoic acid, and 3-hydroxyhexanoic acid. The polyester of the 3 hydroxyalkanoic acid, that is, poly(3-hydroxyalkanoate)-based polymer will be described in detail later.

Examples of the 4-hydroxyalkanoic acid include 4-hydroxybutyric acid, 4-hydroxypentanoic acid, and 4-hydroxyhexanoic acid.

The polyhydroxyalkanoate-based polymer B may be a homopolymer of a hydroxyalkanoic acid or a polymer of two or more hydroxyalkanoic acids.

The poly(3-hydroxyalkanoate)-based polymer is a polyhydroxyalkanoate, that is, a polyester of a hydroxyalkanoic acid, and necessarily contains a repeating unit of a 3-hydroxyalkanoate represented by formula (1). In formula (1), R is a hydrogen atom, a halogen atom, an alkyl group having 1 to 15 carbon atoms, a cyano group, an amino group having 1 to 18 carbon atoms, an alkoxy group (alkyloxy group) having 1 to 11 carbon atoms, an amide group having 1 to 20 carbon atoms, an aryl group having 6 to 12 carbon atoms, or a monovalent heterocyclic group having 1 to 9 carbon atoms. These groups may have a substituent. In particular, from the viewpoint of compatibility with a component (for example, the olefin-based polymer A) except the polymer B contained in the pellet, R is preferably an alkyl group having 1 to 8 carbon atoms, an amide group having 1 to 20 carbon atoms, or an aryl group having 6 to 8 carbon atoms.

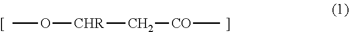

Examples of the halogen atom include F, Cl, Br, and I.

The alkyl group having 1 to 15 carbon atoms may be linear or branched. The number of carbon atoms of the alkyl group is preferably 1 to 8 and more preferably 1 to 4. Examples of the alkyl group include a methyl group, an ethyl group, a propyl group, an isopropyl group, a butyl group, an isobutyl group, a sec-butyl group, a tert-butyl group, a pentyl group, an isopentyl group, a 2-methylbutyl group, a 1-methylbutyl group, a hexyl group, an isohexyl group, a 3-methylpentyl group, a 2-methylpentyl group, a 1-methylpentyl group, a heptyl group, an octyl group, an isooctyl group, a 2-ethylhexyl group, a 3,7-dimethyloctyl group, a nonyl group, a decyl group, an undecyl group, a dodecyl group, a tetradecyl group, and a pentadecyl group.

Examples of the amino group having 1 to 18 or 1 to 11 carbon atoms include an amino group, an alkylamino group, a dialkylamino group, an arylamino group, an alkylarylamino group, a benzylamino group, and a dibenzylamino group.

Examples of the alkylamino group include a methylamino group, an ethylamino group, a propylamino group, a butylamino group, a pentylamino group, a hexylamino group, a heptylamino group, an octylamino group, a nonylamino group, a decylamino group, a dodecylamino group, an isopropylamino group, an isobutylamino group, an isopentylamino group, a sec-butylamino group, a tert-butylamino group, a sec-pentylamino group, a tert-pentylamino group, a tert-octylamino group, a neopentylamino group, a cyclopropylamino group, a cyclobutylamino group, a cyclopentylamino group, a cyclohexylamino group, a cycloheptylamino group, a cyclooctylamino group, a 1-adamantamino group, and 2-adamantamino group.

Examples of the dialkylamino group include a dimethylamino group, a diethylamino group, a dipropylamino group, a dibutylamino group, a dipentylamino group, a diisopropylamino group, a diisobutylamino group, a diisopentylamino group, a methylethylamino group, a methylpropylamino group, a methylbutylamino group, a methylisobutylamino group, a dicyclopropylamino group, a pyrrolidino group, a piperidino group, and a piperazino group.

Examples of the arylamino group include an anilino group, a 1-naphthylamino group, a 2-naphthylamino group, an o-toluidino group, a m-toluidino group, a p-toluidino group, a 1-fluoreneamino group, a 2-fluoreneamino group, a 2-thiazoleamino group, and a p-terphenylamino group.

Examples of the alkylarylamino group include an N-methylanilino group, an N-ethylanilino group, an N-propylanilino group, an N-butylanilino group, an N-isopropylanilino group, and an N-pentylanilino group.

Examples of the alkoxy group having 1 to 11 carbon atoms include a methoxy group, an ethoxy group, a propoxy group, an isopropoxy group, a butoxy group, an isobutoxy group, a sec-butoxy group, a tert-butoxy group, a cyclopropoxy group, a cyclobutoxy group, and a cyclopentoxy group.

The “amide group” means a group obtained by removing one hydrogen atom bonded to a nitrogen atom from a carboxylic amide. Examples of the amide group having 1 to 20 carbon atoms include a group represented by —NH—C(—O)—R^{A} (provided that, R^{A} is a hydrogen atom or a monovalent organic group) such as a formamide group, an acetamide group, a propionamide group, a butyramide group, a benzamide group, a trifluoroacetamide group, or a pentafluorobenzamide group, and a group represented by —N(—C(═O)—R^{A})(—C(═O)—R^{B}) (provided that, R^{A} and R^{B} are each independently a hydrogen atom or a monovalent organic group) such as a diformamide group, a diacetamide group, a dipropioamide group, a dibutyroamide group, a dibenzamide group, a ditrifluoroacetamide group, or a dipentafluorobenzamide group. The organic group can be an alkyl group, an alkoxy group, or an aryl group, which may be substituted with a halogen atom. Among them, the amide group is preferably a formamide group, an acetamide group, a propionamide group, a butyroamide group, or a benzamide group.

Examples of the aryl group having 6 to 12 carbon atoms include a phenyl group, a tolyl group, a xylyl group, a naphthyl group, and a biphenyl group, and among them, a phenyl group, a tolyl group, and a xylyl group are more preferable.

Examples of the heteroatom of the monovalent heterocyclic group having 1 to 9 carbon atoms include N, O, and S, may be saturated or unsaturated, may have a single heteroatom or a plurality of heteroatoms, and may have different types of heteroatoms. Examples of such a heterocyclic group include a thienyl group, a pyrrolyl group, a furyl group, a pyridyl group, a piperidinyl group, a quinolinyl group, an isoquinolinyl group, a pyrimidinyl group, a triazinyl group, and a thiazolyl group.

The repeating unit of the polyhydroxyalkanoate-based polymer B may consist only of one or more kinds of 3-hydroxyalkanoate represented by formula (1), and may have one or more kinds of 3-hydroxyalkanoate represented by formula (1) and one or more kinds of other hydroxyalkanoates.

The polyhydroxyalkanoate-based polymer B preferably contains 50 mol % or more, more preferably 70 mol % or more, of the repeating unit of 3-hydroxyalkanoate represented by formula (1) with respect to the total repeating unit (100 mol %) of the hydroxyalkanoate.

Examples of the 3-hydroxyalkanoate represented by formula (1) include, when R is a hydrogen atom or an alkyl group represented by CₙH₂ₙ₊₁ and n is an integer of 1 to 15, 3-hydroxybutyrate with n=1 (hereinafter, sometimes referred to as 3HB), 3-hydroxyvalerate with n=2 (hereinafter, sometimes referred to as 3HV), 3-hydroxyhexanoate with n=3 (hereinafter, sometimes referred to as 3HH), 3-hydroxyoctanoate with n=5, 3-hydroxyoctadecanoate with n=15, and 3-hydroxypropionate in which R is a hydrogen atom.

Examples of the polyhydroxyalkanoate-based polymer B having only one repeating unit represented by formula (1) include poly(3-hydroxybutyrate) (hereinafter, sometimes referred to as P3HB).

Examples of the polyhydroxyalkanoate-based polymer B having only a plurality of repeating units represented by formula (1) include poly(3-hydroxybutyrate-co-3-hydroxyhexanoate) (hereinafter, sometimes referred to as P3HB3HH), poly(3-hydroxybutyrate-co-3-hydroxyvalerate) (hereinafter, sometimes referred to as P3HB3HV), and poly(3-hydroxybutyrate-co-3-hydroxypropionate (hereinafter, sometimes referred to as P3HB3HP).

Examples of the other hydroxyalkanoates except the 3-hydroxyalkanoate represented by formula (1) include a repeating unit represented by formula (2) (wherein R¹ is a hydrogen atom or an alkyl group represented by CₙH₂ₙ₊₁, n is an integer of 1 or more and 15 or less, and m is an integer of 2 to 10).

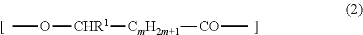

Examples of the polyhydroxyalkanoate-based polymer B containing repeating units of formula (1) and formula (2) include poly(3-hydroxybutyrate-co-4-hydroxybutyrate) (for example, the following formula (P3HB4HB)).

From the viewpoint of increasing the melting point, it is preferable that the repeating unit of the polyhydroxyalkanoate-based polymer B contains at least 3-hydroxybutyrate among 3-hydroxyalkanoate represented by formula (1).

The polyhydroxyalkanoate-based polymer B preferably contains 50 mol % or more, more preferably 70 mol % or more, of the repeating unit of 3-hydroxybutyrate with respect to the total repeating unit (100 mol %) of the hydroxyalkanoate.

The polymer B may have two or more repeating units of ester, and may be, for example, a di-polymer having two repeating units as described above, a tri-copolymer having three repeating units, and a tetra-copolymer having four repeating units.

Examples of the tri-copolymer include poly(3-hydroxybutyrate-co-3-hydroxyvalylate-co-3-hydroxyhexanoate) (hereinafter, sometimes referred to as (P3HB3HV3HH)).

As described above, the polyhydroxyalkanoate-based polymer B preferably contains 3-hydroxybutyrate among the repeating unit of the 3-hydroxyalkanoate represented by formula (1). A ratio XX of the repeating unit of 3-hydroxybutyrate to 100 mol of the ester repeating unit of the total hydroxyalkanoate is preferably 90 mol % or more, more preferably 95 mol % or more, and still more preferably 98.0 mol % or more.

The ratio XX is usually 100 mol % or less, preferably 99.9 mol % or less, and preferably 99.8 mol % or less.

The form of arrangement of the copolymer may be any form of a random copolymer, an alternating copolymer, a block copolymer, a graft copolymer, and the like.

The polyhydroxyalkanoate-based polymer B may have other ester repeating units except those of formula (1) and formula (2), but the main chain of the other ester repeating units does not contain an aromatic hydrocarbon structure. That is, the polyhydroxyalkanoate-based polymer B is an aliphatic polyester. However, it is possible that a group having an aromatic hydrocarbon group is bonded to carbon in the main chain of the other ester repeating unit.

As described in L. Tripathi., M. C. Factories, 11, 44 (2012), the composition ratio of the repeating unit in the polyhydroxyalkanoate-based polymer B can be determined by calculation from the results of NMR measurement such as 1H-NMR and 13C-NMR.

Furthermore, the polyhydroxyalkanoate-based polymer B may be a blend of two or more kinds of polyhydroxyalkanoate-based polymers.

The weight average molecular weight (Mw) of the polyhydroxyalkanoate-based polymer B can be 10000 to 1000000, and is preferably 20000 to 800000 and more preferably 30000 to 600000. When the weight average molecular weight (Mw) is 10000 or more, a molded body excellent in impact strength and tensile elongation can be obtained. Furthermore, when the weight average molecular weight is 500000 or less, the dispersibility in the olefin-based polymer A is improved. The weight average molecular weight may be 400000 or less, 300000 or less, 200000 or less, or 100000 or less. Note that, in the present specification, the weight average molecular weight (Mw) is measured by GPC using standard polystyrene as a molecular weight standard substance.

The polyhydroxyalkanoate-based polymer B is a thermoplastic resin, and is suitably crystalline.

The melt mass flow rate (MFR (B)) of the polymer B as measured according to JIS K7210-2014 under conditions of a temperature of 190° C. and a load of 2.16 kgf is preferably 0.1 g/10 min or more and 200 g/10 min or less. The MFR (B) may be 0.5 g/10 min or more, 1 g/10 min or more, or 1.5 g/10 min or more. The MFR (B) may be 150 g/10 min or less, 100 g/10 min or less, 70 g/10 min or less, 50 g/10 min or less, 30 g/10 min or less, or 20 g/10 min or less.

The melting point (Tm) of the polyhydroxyalkanoate-based polymer B may be 150° C. or higher, 155° C. or higher, 160° C. or higher, 165° C. or higher, 170° C. or higher, or 175° C. or higher. The melting point (Tm) of the polyhydroxyalkanoate-based polymer B can be 220° C. or lower, and may be 200° C. or lower or 190° C. or lower.

The melting point (Tm) of the polyhydroxyalkanoate-based polymer B is measured by the position of a main peak based on melting of a crystal obtained by differential scanning calorimetry (DSC) measurement in accordance with JIS K7121.

The polyhydroxyalkanoate-based polymer B may be produced by microorganisms, and may be derived from a compound (such as a cyclic lactone) derived from a petroleum or plant source.

In the polyhydroxyalkanoate-based polymer B, each repeating unit of the hydroxyalkanoate may consist of only the D-form (R-form) as in the case of a polymer produced from a microorganism, or the repeating unit of the hydroxyalkanoate may include both the D-form (R-form) and the L-form (S-form) as in the case of a polymer derived from a mixture of the D-form (R-form) and the L-form (S-form).

In a poly(3-hydroxyalkanoate)-based polymer produced from a microorganism, the repeating unit of formula (1) can be expressed as in the following formula. In formula (BI-1), n represents the degree of polymerization.

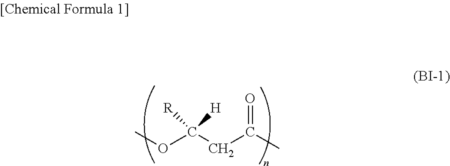

Further, for example, poly-(3-hydroxybutyrate) produced from a microorganism has the structure as described below. In formula (BI-2), n represents the degree of polymerization.

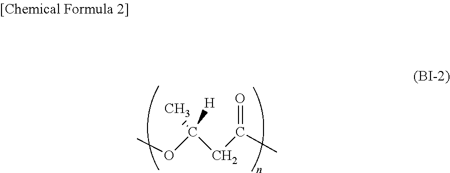

Furthermore, poly-(3-hydroxybutyrate-co-3-hydroxyhexanoate) produced from a microorganism has the structure as described below. In formula (BI-3), m and n represent the degree of polymerization.

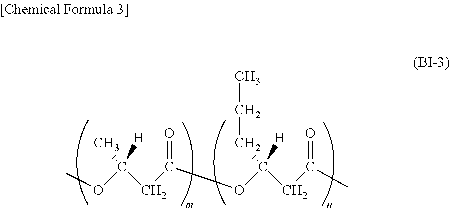

Furthermore, poly-(3-hydroxybutyrate-co-4-hydroxybutyrate) produced from a microorganism has the structure as described below. In formula (BI-4), m and n represent the degree of polymerization.

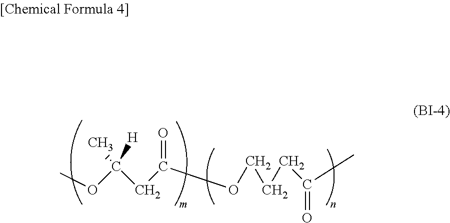

The polymer B can be biodegradable.

For example, the poly(3-hydroxyalkanoate)-based polymer can be produced by microorganisms such as Alcaligeneseutrophus AC32 strain in which PHA synthase enzyme gene derived from Aeromonascaviae was introduced into Alcaligeneseutrophus (international deposit under the Budapest Treaty, international depositary authority: National Institute of Advanced Industrial Science and Technology Center (Center 6, 1-1-1 Higashi, Tsukuba City, Ibaraki Prefecture, Japan), original deposit date: Aug. 12, 1996, transferred on Aug. 7, 1997, accession number FERMBP-6038 (transferred from original deposit FERMP-15786)) (J. Bacteriol., 179, 4821 (1997)).

### (Additive)

The composition may contain an additive as necessary. The additive can be at least one selected from the group consisting of a styrene-based elastomer, a stabilizer, an anti-bacterial agent, an anti-fungal agent, a dispersing agent, a plasticizer, a flame retardant, a tackifier, a colorant, a metal powder, an organic powder, an inorganic fiber, an organic fiber, an organic and inorganic composite fiber, an inorganic whisker, and a filling agent.

Examples of the stabilizer include at least one selected from the group consisting of a lubricant, an anti-aging agent, an antioxidant, a heat stabilizer, a light resistance agent, a weathering agent, a metal deactivator, an ultraviolet absorber, a light stabilizer, and a copper inhibitor. Examples of the light resistance agent include a hindered amine-based light resistance agent.

Examples of the colorant include at least one selected from the group consisting of titanium oxide, carbon black, and an organic pigment. Examples of the metal powder include iron oxide such as ferrite.

Examples of the organic powder include a protein, a polyester (excluding the polyhydroxyalkanoate-based polymer), an aromatic polyamide, cellulose, and vinylon. Examples of the inorganic fiber include a glass fiber and a metal fiber. Examples of the organic fiber include a carbon fiber and an aramid fiber. Examples of the inorganic whisker include potassium titanate whisker.

Examples of the filling agent (filler) include at least one selected from the group consisting of glass powder such as a glass bead, a glass balloon, or a glass flake, silicate mineral, alumina, magnesium oxide, antimony oxide, barium ferrite, strontium ferrite, beryllium oxide, magnesium hydroxide, aluminum hydroxide, basic magnesium carbonate, magnesium carbonate, carbonate mineral, calcium sulfate, magnesium sulfate, basic magnesium sulfate, calcium sulfite, cadmium sulfide, asbestos, mica, calcium carbonate, talc, silica, calcium silicate, hydrotalcite, kaolin, diatomaceous earth, graphite, pumice, ebony powder, cotton flock, cork powder, barium sulfate, fluororesin, cellulose powder, and wood powder. In particular, it is preferable to contain an inorganic filler as an additive. The added amount of the filling agent can be 50 mass % or less with respect to the entire composition.

The shape of the additive when being a particle is not limited, and may be a plate shape, a needle shape, or a fiber shape.

From the viewpoint of the rigidity, impact resistance, and dimensional stability of the pellet and the composition, an inorganic additive is preferable, and talc which is a plate-shaped silicate mineral is more preferable.

The composition may contain only one of the above additives, and may contain a combination of two or more kinds thereof.

In the composition, the additive may be contained in either the olefin-based polymer A or the polyhydroxyalkanoate-based polymer B. The additive may form a dispersed phase different from that of the polymer B in the continuous phase of the olefin-based polymer A.

A loss modulus E″ of the composition with respect to temperature determined by a dynamic mechanical analysis (DMA) method may have a plurality of peaks (for example, two peaks) in the curve, and preferably one peak (a single peak).

In the DMA method, a measurement sample having a thickness of 0.3 mm and cut into strips is heated stepwise at a heating rate of 2° C./min from a measurement temperature of −150° C. in a measurement mode of tension at a measurement frequency of 5 Hz until the sample is melted and cannot be measured. The strain was in a range of 0.1% or less.

When there is only one peak in the curve, the temperature of the peak corresponds to a glass transition temperature Tg. The glass transition temperature Tg of the composition can be −70° C. to 150° C.

### <Constitution of Composition>

The composition contains 99.9 to 70 parts by mass of the olefin-based polymer A and 0.1 to 30 parts by mass of the polyhydroxyalkanoate-based polymer B when a total amount of the olefin-based polymer A and the polyhydroxyalkanoate-based polymer B is 100 parts by mass.

The content of the olefin-based polymer A can be 99 to 70 parts by mass and the content of the polyhydroxyalkanoate-based polymer B can be 1 to 30 parts by mass, the content of the olefin-based polymer A can be 98 to 70 parts by mass and the content of the polyhydroxyalkanoate-based polymer B can be 2 to 30 parts by mass, and the content of the olefin-based polymer A can be 95 to 80 parts by mass and the content of the polyhydroxyalkanoate-based polymer B can be 5 to 20 parts by mass.

The composition can contain 20 parts by mass or less of the polyhydroxyalkanoate-based polymer B when the total amount of the olefin-based polymer A and the polyhydroxyalkanoate-based polymer B is 100 parts by mass.

The total proportion of the olefin-based polymer A and the polyhydroxyalkanoate-based polymer B in the entire composition can be 40 mass % or more, and is preferably 50 mass % or more and more preferably 60 mass % or more.

### (Method for Producing Composition)

The method for producing a resin composition according to the present embodiment includes the following steps.

Step 1: A material 1 containing an olefin-based polymer A is supplied from a main feed port of an extruder to the extruder and melted and kneaded.

Step 2: A material 2 containing a polyhydroxyalkanoate-based polymer B is supplied from a side feed port disposed downstream of the main feed port in the extruder to the extruder and melted and kneaded.

The type of the extruder is not particularly limited as long as it has a barrel and a screw disposed in the barrel, and can melt and knead a raw material of the resin composition to be supplied.

For example, a twin-screw extruder (twin-screw kneader) can be suitably used as the extruder.

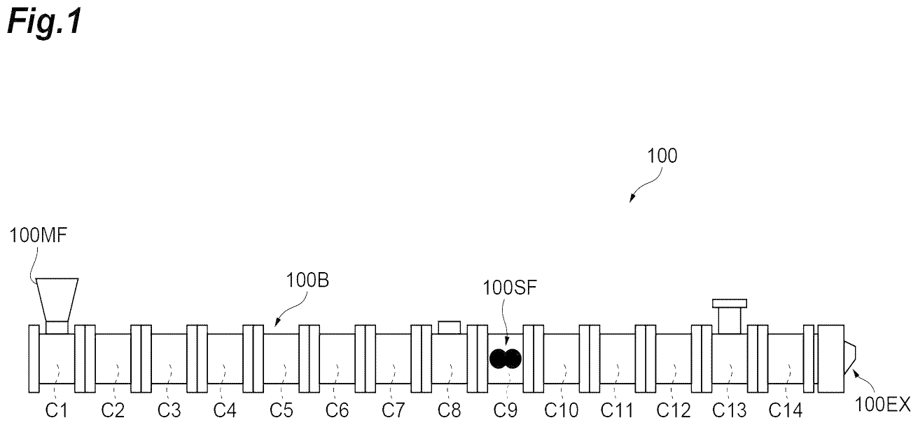

FIG. 1 is a conceptual diagram of an extruder. An extruder 100 has a tubular barrel 100B and screws C1 to C14 arranged in the barrel 100B from upstream to downstream.

A main feed port 100MF which is a most upstream raw material charging port is provided in a portion of the barrel 100B where the most upstream screw C1 is accommodated. An outlet 100EX for discharging the melted and kneaded composition is provided on the downstream side of the most downstream screw C14 in the barrel 100B. A side feed port 100SF as an intermediate raw material charging port is provided in a portion of the barrel 100B on the downstream side of the main feed port 100MF and on the upstream side of the outlet 100EX of the barrel 100B.

The temperature in the barrel in steps 1 and 2 can be appropriately set within a range in which the composition melts. Specifically, the temperature can be, for example, 150 to 210° C.

In step 1, at least a part of the olefin-based polymer A constituting the final composition produced by the extruder may be charged into the main feed port 100MF. In step 1, among the olefin-based polymer A constituting the final composition, it is preferable to supply a certain large amount of the olefin-based polymer A to the main feed port 100MF. In step 1, among the olefin-based polymer A constituting the final composition, 50 mass % or more, 60 mass % or more, 70 mass % or more, 80 mass % or more, 90 mass % or more, 95 mass % or more, or 100 mass % of the olefin-based polymer A may be charged from the main feed port.

The material 1 supplied to the main feed port 100MF in step 1 may be composed of only the olefin-based polymer A, or other resins, additives, and the like may be mixed. It is preferable that the material 1 does not contain the polyhydroxyalkanoate-based polymer B.

In step 2, at least a part of the polyhydroxyalkanoate-based polymer B constituting the final composition produced by the extruder may be charged into the side feed port. In step 2, it is preferable to supply as much polymer B as possible among the polyhydroxyalkanoate-based polymer B constituting the final composition to the side feed port. In step 2, 50 mass % or more, 60 mass % or more, 70 mass % or more, 80 mass % or more, 90 mass % or more, 95 mass % or more, or 100 mass % of the polyhydroxyalkanoate-based polymer B constituting the final composition may be charged from the side feed port.

The material 2 supplied to the side feed port 100SF in step 2 may be composed of only the polyhydroxyalkanoate-based polymer B, or other resins, additives, and the like may be mixed. It is preferable that the material 2 contains a certain amount of the olefin-based polymer A in addition to the polyhydroxyalkanoate-based polymer B.

Specifically, it is preferable that the material 2 containing a polyhydroxyalkanoate-based polymer B contains the olefin-based polymer A at the following mass ratio in addition to the polyhydroxyalkanoate-based polymer B. Here, CA is a mass of the olefin-based polymer A in the material 2, and CB is a mass of the polyhydroxyalkanoate-based polymer B in the material 2.

$${C}_{B} / {C}_{A} = 95 / 5 to 5 / 95$$

The position of the side feed port 100SF is preferably a position where the polyhydroxyalkanoate-based polymer B is sufficiently dispersed in the composition and which is closest to the outlet 100EX of the barrel 100B.

In the present embodiment, the production method may include, for example, a step of extruding the composition obtained by melt-kneading from a die of the outlet to obtain a strand and a step of cutting and cooling the strand, whereby a pellet or the like of the composition is obtained.

### Effect

According to the production method of the above aspect, the mechanical strength of the resulting molded body of the resin composition can be increased. The reason for this is not clear, but the following situations are conceivable.

In the present embodiment, the olefin-based polymer A is added from the main feed port of the extruder, and the polyhydroxyalkanoate-based polymer B is added from the side feed port on the downstream side of the main feed port. Therefore, the time during which the polyhydroxyalkanoate-based polymer is exposed to a high-temperature atmosphere can be reduced as compared with a case where both the olefin-based polymer A and the polyhydroxyalkanoate-based polymer B are charged from the main feed port. Thus, it is considered that deterioration (thermal decomposition) and the like in the melting/kneading process of the polyhydroxyalkanoate-based polymer B are suppressed, and the polyhydroxyalkanoate-based polymer B is excellent in mechanical strength.

### (Method for Producing Molded Body Using Composition)

A method for producing a molded body according to the present embodiment includes a step of supplying the composition (for example, in the form of a pellet) to a raw material supply port of a molding machine and molding the composition with the molding machine to produce a molded body. Note that a raw material except the above-described composition may be added to the raw material supply port of the molding machine.

For molding, a known resin molding method such as an injection molding method, an extrusion molding method, a vacuum molding method, a compression molding method, a press molding method, a foam molding method, a blow molding method, or a rotation molding method can be used. The shape of the molded body to be obtained is not particularly limited.

The above-described molded body can be widely used as a resin material.

Examples of use applications of the molded body of the composition of the present invention include external structural members, furniture and interior decorative members, household electric appliance members, toy members, gardening members, automobile members, and packaging materials. Examples of the external structural members include a carport member, a fence member, a gate door member, a gate pillar member, a post member, a cycle port member, a deck member, a sunroom member, a roof member, a terrace member, a handrail member, a shade member, and an awning member, examples of the furniture and interior decorative members include a sofa member, a table member, a chair member, a bed member, a chest member, a cabinet member, and a dresser member, examples of the household electrical appliance members include a member for a watch, a mobile phone member, and a white home electric appliance member, examples of the toy members include a member for a plastic model, a member for a diorama, and a member for a video game main body, examples of the gardening members include a member for a planter, a member for a vase, and a member for a flowerpot, examples of the automobile members include a bumper material, an instrument panel material, and an airbag cover material, and examples of the packaging materials include a food packaging material, a packaging material for fiber, and a packaging material for miscellaneous goods. Further, examples of other use applications include monitor members, office automation (OA) equipment members, medical members, drainage pans, toiletry members, bottles, containers, snow remover members, and various building members.

In particular, the molded body is preferably a component for automobiles. Examples of the automobile component include a bumper, a grill, a side molding, a mud guard, and an under cover. Examples of other automobile components include an instrument panel, a door panel, a pillar, a scuff, a cowl, a toolbox, a finish end, and a tailgate.

### EXAMPLES

Hereinafter, the present invention will be specifically described with reference to Examples. However, the present invention is not limited to Examples described below.

In the following description, “%” and “part(s)” representing amounts are based on mass unless otherwise specified. Furthermore, the operations described below were performed under the conditions of normal temperature and normal pressure unless otherwise specified.

### Components Used in Examples and Comparative Examples

The components used in Examples and Comparative Examples are shown below.

### (Olefin-Based Polymer A)

### (Propylene-Based Polymer (A-1): Heterophasic Propylene Polymerization Material)

A heterophasic propylene polymerization material (A-1) as a propylene-based polymer was produced by a liquid-gas phase polymerization method using a polymerization catalyst obtained by the method described in Example 1 of Japanese Unexamined Patent Publication No. 2004-182981. The physical properties were as follows.
Melt flow rate (230° C., 21.18 N load): 63 g/10 min
Propylene homopolymer component
Intrinsic viscosity number: 0.86 dL/g
Ethylene-propylene random copolymer component
Intrinsic viscosity number: 5.1 dL/g
Content of structural unit derived from ethylene: 30 mass %

### (Propylene-Based Polymer (A-2): Propylene Homopolymer)

A propylene homopolymer (A-2) as a propylene-based polymer was produced by a liquid-gas phase polymerization method using a polymerization catalyst obtained by the method described in Example 1 of Japanese Unexamined Patent Publication No. 2004-182981. The physical properties were as follows.
Melt flow rate (230° C., 21.18 N load): 120 g/10 min
Intrinsic viscosity number: 0.93 dL/g

Here, the intrinsic viscosity number (unit: dL/g) means a value measured at a temperature of 135° C. using tetralin as a solvent by the following method.

The intrinsic viscosity number (unit: dL/g) was determined by an “extrapolation method” in which values of reduced viscosity are measured for a plurality of concentrations using an Ubbelohde viscometer, respectively, the values of reduced viscosity are plotted with respect to the concentrations, respectively, and a concentration is extrapolated to zero.

More specifically, the intrinsic viscosity number was determined by a method for measuring values of reduced viscosity for three points of concentrations of 0.1 g/dL, 0.2 g/dL, and 0.5 g/dL, respectively, using the method described on page 491 of “Polymer Solution, Polymer Experiment 11” (published by KYORITSU SHUPPAN CO., LTD., 1982), plotting the values of reduced viscosity with respect to the concentrations, respectively, and extrapolating a concentration to zero.

### (Polyhydroxyalkanoate-Based Polymer B)

Manufactured by Newlight Technologies: poly(3-hydroxybutyrate)
Melt flow rate (190° C., 21.18 N load): 1.8 g/10 min

### (Thermoplastic Elastomers (A-3, A-4))

### (A-3) Ethylene-Octene Random Copolymer

Manufactured by Dow Chemical Japan Co., Ltd.: ENGAGE EG8842
Density: 0.857 (g/cm3)
MFR (190° C., 21.18 N load): 1.0 g/10 min

### (A-4) Ethylene-Butene Random Copolymer

Manufactured by Dow Chemical Japan Co., Ltd.: ENGAGE EG7467
Density: 0.862 (g/cm3)
MFR (190° C., 21.18 N load): 1.2 g/10 min

### (Inorganic Filler (D))

Talc manufactured by HAYASHI KASEI CO., LTD.: MWUPN-TT-H

The following components were used as additives.

### (Additive 1)

“Calcium Stearate” manufactured by SAKAI CHEMICAL INDUSTRY CO., LTD.

### (Additive 2)

“SUMILIZER GA80” manufactured by Sumitomo Chemical Co., Ltd.

### (Additive 3)

“IRGAFOS168” manufactured by BASF

### (Additive 4)

“SUMILIZER TPM” manufactured by Sumitomo Chemical Co., Ltd.

### (Additive 5)

“Sumisorb 400” manufactured by Sumika Chemtex Co., Ltd.

### (Additive 6)

“ADK STAB LA-52” manufactured by ADEKA CORPORATION

### (Additive 7)

“ALFLOW H-50S” manufactured by NOF Corporation

### (Additive 8)

“Electrostripper TS-5” manufactured by Kao Corporation

### Example 1

All components of 40 parts by weight of the propylene-based polymer (A-1), 10 parts by weight of a thermoplastic elastomer ENGAGE EG8842 (A-3), 10 parts by weight of a thermoplastic elastomer ENGAGE EG7467 (A-4), 20 parts by weight of an inorganic filler MWUPN-TT-H (D), and as additives, 0.05 parts by weight of “Calcium Stearate”, 0.05 parts by weight of “SUMILIZER GA80”, 0.05 parts by weight of “IRGAFOS168”, 0.03 parts by weight of “SUMILIZER TPM”, 0.15 parts by weight of “Sumisorb 400”, 0.15 parts by weight of “ADK STAB LA-52”, 0.05 parts by weight of “ALFLOW H-50S”, and 0.1 parts by weight of “Electrostripper TS-5” were mixed, and the mixture was charged from the main feed port 100MF on the most upstream side of a twin-screw kneader TEX44αII manufactured by The Japan Steel Works, Ltd. Further, all components of 14.5 parts by weight of the propylene-based polymer (A-1), 0.5 parts by weight of the propylene-based polymer (A-2), and 5 parts by weight of poly(3-hydroxybutyrate) (B) were mixed, and the mixture was charged from the intermediate side feed port 100SF of the twin-screw kneader TEX44αII. The cylinder temperature was set to 180° C., the screw rotation speed was set to 200 rpm, two sheets of screen meshes of 80 mesh and 40 mesh were stacked, and the mixture was melt-kneaded under the condition of a discharge amount of 60 kg/hr and discharged from a die at an outlet to prepare a pellet-shaped propylene-based resin composition. The resin temperature of the molten resin at the outlet of the kneader was 211° C. In the screw of the twin-screw kneader TEX44αII, in FIG. 1, a kneading unit combined with a kneading disc was installed at positions of C5 to C7 and C12, and a segment for conveyance was installed in the other part.

### Example 2

All components of 40 parts by weight of the propylene-based polymer (A-1), 10 parts by weight of a thermoplastic elastomer ENGAGE EG8842 (A-3), 10 parts by weight of a thermoplastic elastomer ENGAGE EG7467 (A-4), 20 parts by weight of an inorganic filler MWUPN-TT-H (D), and as additives, 0.05 parts by weight of “Calcium Stearate”, 0.05 parts by weight of “SUMILIZER GA80”, 0.05 parts by weight of “IRGAFOS168”, 0.03 parts by weight of “SUMILIZER TPM”, 0.15 parts by weight of “Sumisorb 400”, 0.15 parts by weight of “ADK STAB LA-52”, 0.05 parts by weight of “ALFLOW H-50S”, and 0.1 parts by weight of “Electrostripper TS-5” were mixed, and the mixture was charged from the main feed port 100MF on the most upstream side of a twin-screw kneader TEX44αII manufactured by The Japan Steel Works, Ltd. Further, all components of 9.5 parts by weight of the propylene-based polymer (A-1), 0.5 parts by weight of the propylene-based polymer (A-2), and 10 parts by weight of the poly(3-hydroxybutyrate) (B) were mixed, the mixture was charged from the intermediate side feed port 100SF of the twin-screw kneader TEX44αII, the cylinder temperature was set to 180° C., the screw rotation speed was set to 200 rpm, two sheets of screen meshes of 80 mesh and 40 mesh were stacked, and the mixture was melt-kneaded under the condition of a discharge amount of 60 kg/hr and discharged from a die to prepare a pellet-shaped propylene-based resin composition. The resin temperature of the molten resin at the outlet of the kneader was 211° C. In the screw of the twin-screw kneader TEX44αII, a kneading unit combined with a kneading disc was installed at positions of C5 to C7 and C12, and a segment for conveyance was installed in the other part.

### Comparative Example 1

All components of 54.5 parts by weight of the propylene-based polymer (A-1), 0.5 parts by weight of the propylene-based polymer (A-2), 5 parts by weight of the poly(3-hydroxybutyrate) (B), 10 parts by weight of a thermoplastic elastomer ENGAGE EG8842 (A-3), 10 parts by weight of a thermoplastic elastomer ENGAGE EG7467 (A-4), 20 parts by weight of an inorganic filler MWUPN-TT-H (D), and as additives, 0.05 parts by weight of “Calcium Stearate”, 0.05 parts by weight of “SUMILIZER GA80”, 0.05 parts by weight of “IRGAFOS168”, 0.03 parts by weight of “SUMILIZER TPM”, 0.15 parts by weight of “Sumisorb 400”, 0.15 parts by weight of “ADK STAB LA-52”, 0.05 parts by weight of “ALFLOW H-50S”, and 0.1 parts by weight of “Electrostripper TS-5” were mixed, the mixture was charged from the main feed port 100MF on the most upstream side of a twin-screw kneader TEX44αII manufactured by The Japan Steel Works, Ltd., the cylinder temperature was set to 180° C., the screw rotation speed was set to 200 rpm, two sheets of screen meshes of 80 mesh and 40 mesh were stacked, and the mixture was melt-kneaded under the condition of a discharge amount of 60 kg/hr and discharged from a die to prepare a pellet-shaped propylene-based resin composition. The resin temperature of the molten resin at the outlet of the kneader was 214° C. In the screw of the twin-screw kneader TEX44αII, a kneading unit combined with a kneading disc was installed at positions of C5 to C7 and C12, and a segment for conveyance was installed in the other part.

### Comparative Example 2

All components of 49.5 parts by weight of the propylene-based polymer (A-1), 0.5 parts by weight of the propylene-based polymer (A-2), 10 parts by weight of the poly(3-hydroxybutyrate) (B), 10 parts by weight of a thermoplastic elastomer ENGAGE EG8842 (A-3), 10 parts by weight of a thermoplastic elastomer ENGAGE EG7467 (A-4), 20 parts by weight of an inorganic filler MWUPN-TT-H (D), and as additives, 0.05 parts by weight of “Calcium Stearate”, 0.05 parts by weight of “SUMILIZER GA80”, 0.05 parts by weight of “IRGAFOS168”, 0.03 parts by weight of “SUMILIZER TPM”, 0.15 parts by weight of “Sumisorb 400”, 0.15 parts by weight of “ADK STAB LA-52”, 0.05 parts by weight of “ALFLOW H-50S”, and 0.1 parts by weight of “Electrostripper TS-5” were mixed, the mixture was charged from the main feed port 100MF on the most upstream side of a twin-screw kneader TEX44αII manufactured by The Japan Steel Works, Ltd., the cylinder temperature was set to 180° C., the screw rotation speed was set to 200 rpm, two sheets of screen meshes of 80 mesh and 40 mesh were stacked, and the mixture was melt-kneaded under the condition of a discharge amount of 60 kg/hr to prepare a pellet-shaped propylene-based resin composition. The resin temperature of the molten resin at the outlet of the kneader was 214° C. In the screw of the twin-screw kneader TEX44αII, a kneading unit combined with a kneading disc was installed at positions of C5 to C7 and C12, and a segment for conveyance was installed in the other part.

### [Evaluation]

### (1) Tensile Elongation at Break (Unit: %)

Using an injection molding machine: M70 manufactured by MEIKI CO., LTD., the pellet of each example obtained above was injection molded as a raw material under the conditions of a molding temperature of 197° C. and a mold cooling temperature of 40° C. to prepare a test piece of mold cavity shape: ISO mold type A, and measurement was performed at a tensile rate of 50 mm/min and at a temperature of 23° C. according to JIS K7161.

### (2) Charpy Impact Test (Unit: KJ/m2)

Using an injection molding machine: M70 manufactured by MEIKI CO., LTD., the pellet of each example obtained above was injection molded as a raw material under the conditions of a molding temperature of 197° C. and a mold cooling temperature of 40° C. to prepare a test piece of mold cavity shape: ISO mold type A, the test piece of 10 mm (width)×80 mm (length)×4 mm (thickness) was notched, and measurement was performed at a temperature of 23° C. and −30° C. according to JIS K7111.

### (3) Molded Article Hue L*(Unit: −)

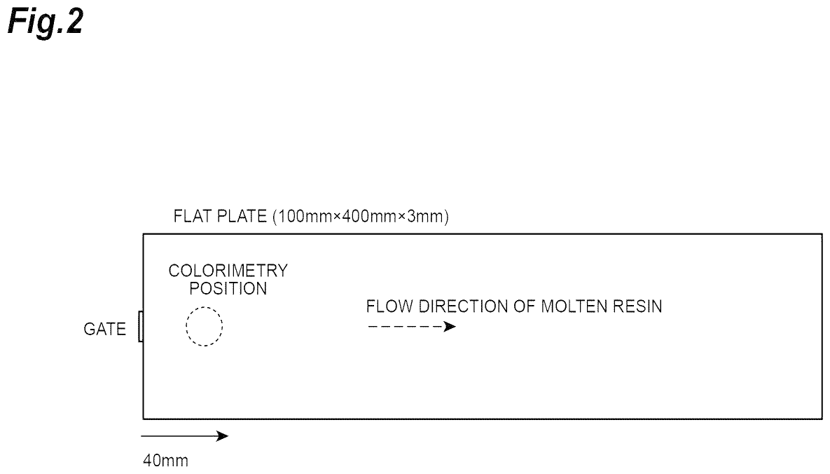

Using an injection molding machine: SE180D manufactured by Sumitomo Heavy Industries, Ltd., the pellet of each example obtained above was injection molded as a raw material under the conditions of a molding temperature of 200° C. and a mold cooling temperature of 50° C. to mold a flat plate having a test piece shape of 100 mm (width)×400 mm (length)×3 mm (thickness) as illustrated in FIG. 2. Using the molded flat plate, a position of 40 mm from the gate portion of the test piece in a flow direction of the resin was colorimetrically measured at a measurement angle of 45° using a multi-angle colorimeter BYK-mac 12 mm manufactured by BYK, and an L* value was obtained.

TABLE 1

| | | | Compar- | | Compar- |
|---|---|---|---|---|---|
| | | Exam- | ative | Exam- | ative |
| | | ple 1 | Example 1 | ple 2 | Example 2 |
| Charging | Propylene-based | 40 | 54.5 | 40 | 49.5 |
| port (C1) | polymer (A-1) | | | | |
| on most | Propylene-based | — | 0.5 | — | 0.5 |
| upstream | polymer (A-2) | | | | |
| side | Polyhy- | — | 5 | — | 10 |
| | droxyalkanoate | | | | |
| | (B) | | | | |
| | Thermoplastic | 10 | 10 | 10 | 10 |
| | elastomer (A-3) | | | | |
| | Thermoplastic | 10 | 10 | 10 | 10 |
| | elastomer (A-4) | | | | |
| | Inorganic filler | 20 | 20 | 20 | 20 |
| | (D) | | | | |
| Interme- | Propylene-based | 14.5 | — | 9.5 | — |
| diate | polymer (A-1) | | | | |
| charging | Propylene-based | 0.5 | — | 0.5 | — |
| port | polymer (A-2) | | | | |
| (C9) | Polyhy- | 5 | — | 10 | — |
| | droxyalkanoate | | | | |
| | (B) | | | | |
| Physical | Tensile elonga- | 45 | 41 | 29 | 25 |
| properties | tion at | | | | |
| | break [%] | | | | |
| | Charpy impact | 51.9 | 49.3 | 41.2 | 35.5 |
| | test (23° C. | | | | |
| | N) [kJ/m²] | | | | |
| | Charpy impact | 4.4 | 3.8 | 3.1 | 3.0 |
| | test (−30° C. | | | | |
| | N) [kJ/m²] | | | | |
| | Molded article | 13.9 | 16.6 | 16.2 | 16.9 |
| | hue (L*) 45° | | | | |

In Examples in which the polyhydroxyalkanoate was supplied from the side feed port, the physical properties of the strength of the molded body were improved as compared with the corresponding Comparative Examples.

### REFERENCE SIGNS LIST

100MF main feed port
100SF side feed port
100B barrel
C1 to C14 screw or kneader
100 extruder

1. A method for producing a composition containing an olefin-based polymer A and a polyhydroxyalkanoate-based polymer B,
the composition containing 99.9 to 70 parts by mass of the olefin-based polymer A and 0.1 to 30 parts by mass of the polyhydroxyalkanoate-based polymer B when a total amount of the olefin-based polymer A and the polyhydroxyalkanoate-based polymer B is 100 parts by mass,
the method comprising:
a step of supplying a material 1 containing the olefin-based polymer A from a main feed port of an extruder to the extruder to melt and knead the material 1; and
a step of supplying a material 2 containing the polyhydroxyalkanoate-based polymer B from a side feed port disposed downstream of the main feed port in the extruder to the extruder to melt and knead the material 2.

2. The method according to claim 1, wherein the material 2 containing the polyhydroxyalkanoate-based polymer B contains the polyhydroxyalkanoate-based polymer B and the olefin-based polymer A at the following mass ratio, provided that CA is a mass of the olefin-based polymer A in the material 2, and CB is a mass of the polyhydroxyalkanoate-based polymer B in the material 2,
$${C}_{B} / {C}_{A} = 95 / 5 to 5 / 95.$$

3. The method according to claim 1, wherein the olefin-based polymer A contains a propylene-based polymer.

4. The method according to claim 1, wherein the polyhydroxyalkanoate-based polymer B contains a structural unit of 3-hydroxybutyrate.

5. The method according to claim 1, wherein the olefin-based polymer A contains an olefin-based elastomer having a monomer unit derived from an α-olefin having 3 to 20 carbon atoms and a monomer unit derived from ethylene.

6. The method according to claim 1, wherein the composition contains an inorganic filler (D).

7. The method according to claim 1, wherein the composition contains 20 parts by mass or less of the polyhydroxyalkanoate-based polymer B when the total amount of the olefin-based polymer A and the polyhydroxyalkanoate-based polymer B is 100 parts by mass.

8. The method according to claim 1, wherein the composition is used for injection molding.

9. A composition obtained by the method for producing a composition according to claim 1.

10. A molded body of the composition according to claim 9.

11. The molded body according to claim 10, wherein the molded body is a component for automobiles.

12. The molded body according to claim 11, wherein the component for automobiles is a bumper, a grill, a side molding, a mud guard, or an under cover.

13. The molded body according to claim 11, wherein the component for automobiles is an instrument panel, a door panel, a pillar, a scuff, a cowl, a toolbox, a finish end, or a tailgate.
